(19) United States
(12) Patent Application Publication
(10) Pub. No.: US 2001/0005115 A1
(43) Pub. Date: Jun. 28, 2001

(54) Plasma display device and method of manufacturing a plasma display device comprising a dielectric layer

(75) Inventors: Johannes Maria Marcus Busio, Eindhoven (NL); Siebe Tjerk De Zwart, Eindhoven (NL); Henricus Albertus Maria Van Hal, Eindhoven (NL)

Correspondence Address: Jack E. Haken, U.S. Philips Corporation, 580 White Plains Road, Tarrytown, NY, 10591, US

(73) Assignee: U.S. PHILIPS CORPORATION

(21) Appl. No.: 09/741,666

(22) Filed: Dec. 19, 2000

(30) Foreign Application Priority Data
Dec. 22, 1999 (EP) 99204473.5

(51) Int. Cl. H01J 17/49

(52) U.S. Cl. 313/586; 313/582

(57) ABSTRACT

A plasma display device comprises a discharge chamber (11, 22), and electrodes (3, 4, 8, 24, 25). The electrodes are covered by a dielectric layer (5, 9, 22). Said dielectric layer comprises a metal oxide matrix comprising alkyl groups.

The invention relates to a plasma display device comprising a dielectric layer separating electrodes form a discharge chamber. The invention relates to a method of manufacturing a plasma display device comprising a dielectric layer separating electrodes from a discharge chamber.

Plasma display devices can be used in so-called PDP (plasma display panels) and in PALC-LCD devices.

From EP 0 784 333 a plasma display panel (PDP) which comprises a dielectric layer separating electrodes from a discharge chamber is known. Conventionally the dielectric layer is made by applying a frit glass paste and raising the temperature to high temperatures (typically 580° C.) to form a transparent glass layer. Raising the temperature to such high values, however, requires the use of glass for other parts of the Plasma Display Panel (in particular a display's front and rear substrate) which can withstand such temperatures. Normal float glass has a strain point well below the indicated temperature. Conventionally it has been tried to overcome these problems either by the use of special glass for the other parts or by using very slow warm-up and cool down procedures, which seriously increases the manufacturing costs and the complexity of the manufacturing set-up.

To resolve at least partly these problems it has been described in EP 784333 to use a gel comprising a metal alkoxide. In an example (column 16) an electric layer is formed by coating an n-butanol solution comprising Si(OC₄H₉)₄ is applied to a surface by a doctor blade method and subsequently heated to a temperature of 100-400° C. to provide a display device comprising a dielectric layer comprising silicon oxide.

Although the known device and method solves some problems, yet further problems still exist.

The dielectric layer itself often shows cracks after being formed. Such cracks (craquelé) often cause break-downs (i.e. during discharge current runs directly to an electrode). Such flash-overs may damage the electrodes or the dielectric layer and strongly reduce the functioning of the PDP. Craquelé also has a negative effect on the optical properties of the PDP because light may be erratically reflected off the cracks. Furthermore pin-holes in the dielectric layer may occur, which have a similar effect. In EP 784 333 the thickness of the dielectric layer is 0.003 to 0.01 mm (3 to 10 micrometer). Increasing the thickness of the dielectric layer reduces the occurrence of pin-holes, but increases the occurrence of craquele, as the inventors have found.

It is an object of the invention to provide for a plasma display device and a method of manufacturing a plasma display device in which one or more of the above mentioned problems are reduced and preferably minimized.

It is a further object to maintain a high light output during lifetime.

To this end the plasma display device in accordance with the invention is characterized in that the dielectric layer comprises an silicon oxide matrix in which alkyl groups are present.

In the plasma display device in accordance with the invention the dielectric layer comprises alkyl groups. These groups reduce the formation of cracks, reducing the occurrence of break-downs. Without being bound to any theoretical explanation it is assumed that the alkyl groups within the matrix formed by the interconnected Si and O atoms render the layer more mechanically flexible. Adverse effects of differences in thermal expansion between the dielectric layer and the underlying substrate can thereby be better accommodated, resulting in less cracks. Apart from reducing the occurrence of breakdowns, it also enables the formation of layers thicker than 10 micrometer, preferably thicker than 15 micrometer. The increased thickness reduces the occurrence of pin-holes.

Preferably the dielectric layer comprises more than one sub-layer. The occurrence of pin-holes is reduces by application of more than one sub-layer. Any pin-holes in a first sub-layer are preferably filled up by the second sub-layer removing pin-holes, and thereby reducing the risk of break-downs.

The method in accordance with the invention is characterized in that a precursor layer is applied to a substrate comprising electrodes, the precursor layer comprising a metal alkoxide comprising, bound to the metal atom, an alkyl group and said precursor layer is subsequently converted to the dielectric layer.

During conversion the alkoxy groups (-Oalkyl) react with one another to form a metal atom-O network. The alkyl group or groups however do not take part in these reaction and render the dielectric layer more resistant to the formation of cracks and make it possible to provide layers thicker than 10 micrometer.

Preferably the metal alkoxide comprises a single alkyl group, the metal atom being further surrounded by alkoxy groups. A high dielectric constant is generally better. The dielectric constant of the dielectric layer is dependent on the number alkyl groups and in general is reduced by the presence of more than one groups. Preferably the alkyl groups are ethyl or methyl groups (even more preferably methyl). The larger the alkyl group is, the more the dielectric constant is reduced and the more difficult the alkyl groups can be accommodated into the matrix. An example in which a mixture of dimethyldimethoxysilane (DMDMS) and methyltrimethoxysilane (MTMS) was used showed that the maximum thickness for such mixture (before craquel┌ occurred was reduced in comparison to the use of MTMS only. The metal can be for instance aluminium, silicon (which is preferred due to optical and dielectric properties of siliconoxide) or boron or any mixture of metalalkoxides as long as one of the constituent metalalkoxides comprises an alkylgroup.

To protect the dielectric layer against degradation by UV radiation from the discharge chamber a protective layer, absorbing UV radiation (e.g. a ZrO₂-layer) is preferably present between the dielectric layer and the discharge chamber.

These and other objects of the invention will be apparent from and elucidated with reference to the embodiments described hereinafter.

In the drawings:

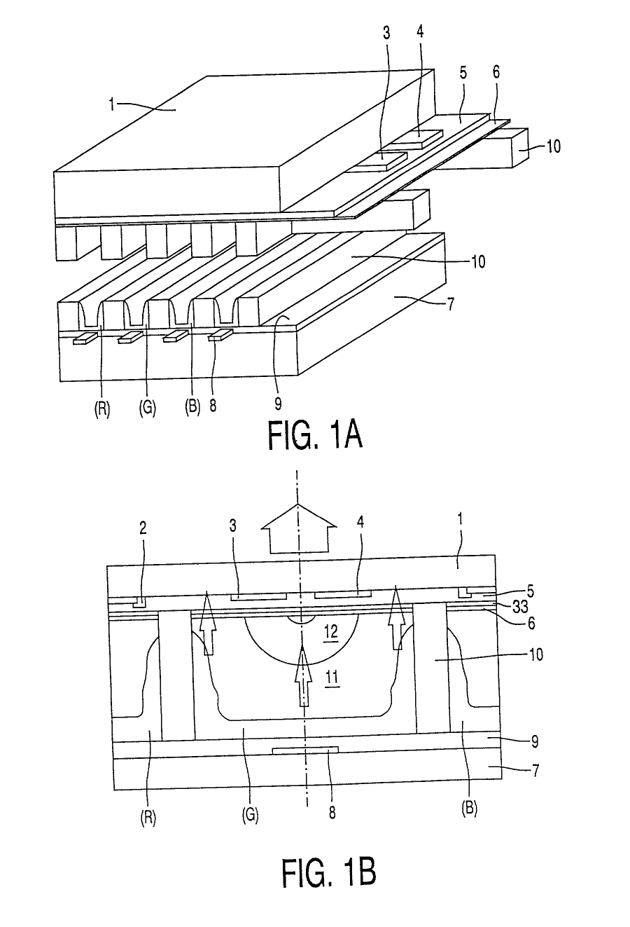

FIGS. 1A and B show in a partially cut-out respectively a sectional view an example of a plasma display device, a PDP device.

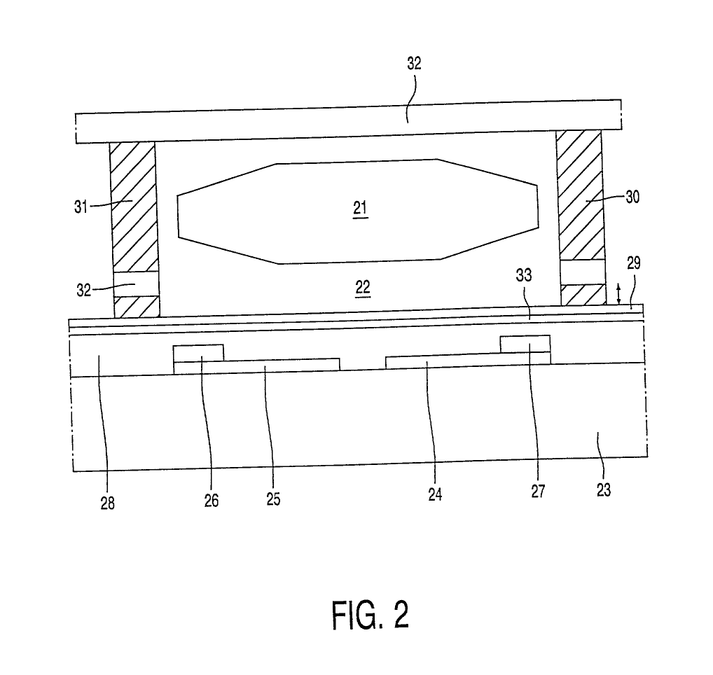

FIG. 2 shows schematically a sectional view of part of a PALC-LCD device.

The Figures are not drawn to scale. In the Figures, like reference numerals generally refer to like parts. The examples show display devices of the AC type.

FIG. 1 shows a color plasma display panel (PDP) comprising a face glass substrate 1, with a group of transparent electrodes (e.g. comprising for instance bus electrodes 2, scan electrodes 3 and sustain electrodes 4), a dielectric layer 5 usually covered with a protection layer 6 comprising e.g. MgO. The PDP further comprises a back plate 7, with data electrodes 8 and a dielectric layer 9. In between the back plate and the face glass substrate in this examples barrier ribs 10 are provided which define discharge chamber 11. In this example (a color PDP) the discharge chambers are internally sequentially coated with red (R), green (G) and blue (B) phosphors. The substrates 1 and 7 are laid together with a small space (e.g. in the order of 0.1 mm) between them, forming a number of light emitting cells, where two groups of electrodes intersect. Each light emitting cell forms a tiny space divided from other cells by the barrier ribs 10. Each cell contains a rare gas such as Xenon. When voltage is applied between the scan and sustain electrodes (which are both transparent) discharge occurs 12 in the rare gas in the selected light emitting cell (FIG. 1B). That energizes the gas to generate ultraviolet radiation indicated in FIG. 1B by broken arrows, which in turn energizes phosphors in the light-emitting cell to generate visible (Red, green or blue, depending on the phosphor) light in FIG. 1B indicated by small arrows. The visible light, indicated in FIG. 1B by a large arrow emerges through the front of the PDP through the face glass substrate. The light of a number of light emitting cells forms color images.

The dielectric layers 5 and 9 are conventionally made by applying a glass frit paste and heating it to high temperature (580° C.). As explained the high temperature to be used to convert the glass frit paste into a transparent dielectric layer cause problems.

In EP 784 333 these problems are partially overcome by applying using a doctor blade method a gel comprising metal alkoxides.

### EXAMPLE

The following sol-gel was made:

200 gram colloidal silica (Ludox®) was mixed with

200 gram methyltrimethoxysilane (CH₃Si(O—CH₃)₃) (MTMS)

18 gram acetic acid and

5 gram tetraethylorthosilicate (TEOS).

A layer was administered using the so-called doctor blade method.

After heating to 400° C. a clear well-adhering transparent dielectric layer with a thickness of 10 micrometer (±1 to 2 micrometer) was formed (in an inert gas atmosphere like for instance nitrogen, the material can be heated to 500 to 550° C.). Using the doctor blade method a maximum thickness of approximately 30 micrometer could be obtained. Thicker layers would crackle. These relatively large thicknesses are obtainable due to the presence of MTMS (or more precisely the alkyl groups in the MTMS). During the formation of the dielectric layer the alkoxy groups (-Oalkyl) react with each other forming oxygen bridges. The alkyl groups however do not participate in these reactions but are incorporated in the dielectric layer. There presence in the dielectric layer is shown in infra-red measurements. In the infra-red spectrum a band around 3000 cm⁻¹ is present corresponding to the C—H vibrational band The less than complete number of interconnections between the Si and O atoms presumably results in a better mechanical flexibility of the dielectric layer. As a result during heating of the pre-cursor to obtain the dielectric layer differences in thermal expansion between the dielectric layer and the substrate can be more easily accommodated and as a result the layer shows much less cracks. Compared to dielectric layers made from glass frit paste it was also found that the transparency of layers of equivalent thickness had increased. A higher transparency is an advantage since any loss of light in the dielectric layer reduces the brightness of the display device.

Preferably the layer is provided by means of a dip-coating technique. The dip coating technique has shown to result in layers which have a better controlled thickness. In the dip coating technique the substrate is dipped in a solution and slowly withdrawn from the solution. A layer of solution remains on the surface. This method has a number of advantages. It was found that the thickness could be better controlled. The thickness of the dielectric layer has an influence on the performance of the device, so the better the thickness may be controlled the better it is. Furthermore when two layers are provided, the dip coating technique gives better results as far as controlling the thickness is concerned and as far as the occurrence of pin holes in the dielectric layer is concerned.

During operation of the PDP-device ultra-violet radiation is generated mainly with emission spectra around 147 nm and 172 nm. As this radiation has degradational influence on the sol-gel material of dielectric layer 5 this layer asually is covered with a protective layer of M_{g}O. Experiment showed however that, even while using M_{g}O as a protective layer some degration occurred and consequently a lower light output was obtained. This is probably due to the fact that M_{g}O does not completely absorb the UV radiation at λ>175 nm. To overcome this an extra layer 33 absorbing at wavelength above 175 nm was introduced. A suitable layer contains ZrO₂ and has a thickness of 0.2-2 μm (in this example 0.5 μm).

It will be clear that within the framework of the invention many variations are possible.

In the examples for instance mention is made of so called PDP devices. The invention, although in particular advantageous for this kind of devices is, in its broadest scope, not restricted to these kind of devices. FIG. 2 shows in a sectional view a part of a so-called PALC-device. In such devices gas discharges 21 are generated in a discharge chamber 22. A substrate 23 is provided with electrodes 24 and 25 and circuits 26 and 27. Over the electrodes and between the substrate 23 and the discharge chamber 22 a dielectric layer 28 is provided which may be covered by a protective coating 29. The discharge chamber is formed between ribs 30 and 31, substrate 23 and an overlying microsheet 32. In the ribs auxiliary electrodes 33 may be incorporated. With the discharge 21 an LCD element (not shown in FIG. 2) above the microsheet is switched. Reduction of flash-overs, and/or a good control over the thickness of the layer and and/or a reduction of (the risk of) cracks is also of importance for the dielectric layer.

1. Plasma display device comprising a dielectric layer (5, 9, 28) separating electrodes (2, 4, 3, 8, 25, 24) from a discharge chamber (11, 22), characterized in that the dielectric layer (5, 9, 28) comprises a transparent metal oxide matrix in which alkyl groups are present.

2. Plasma display device as claimed in claim 1, characterized in that the dielectric layer (5, 9, 28) is thicker than 10 micrometer; Plasma display device as claimed in claim 2, characterized in that the dielectric layer is thicker than 15 micrometer.

3. Plasma display device as claimed in claim 1, characterized in that the dielectric layer comprises more than one sub-layer.

4. Plasma display device as claimed in claim 1, characterized in that the transparent metal oxide is silicon oxide.

5. Plasma display device as claimed in claim 1, characterized in that the alkyl group is methyl or ethyl.

6. Plasma display device as claimed in claim 6, characterized in that the alkyl group is methyl.

7. Plasma display device according to claim 1 characterized in that a layer (33) absorbing radiation having a wavelength λ≧175 nm is present between the dielectric layer (5, 9, 2, 8) and the discharge chamber (11, 22).

8. Plasma display device according to claim 7 characterized in that the absorbing layer (33) comprises zirconium oxyde.

9. Method of manufacturing a plasma display device comprising electrodes (2, 3, 4, 8, 24, 25) and a discharge chamber (11, 22) in which device a dielectric layer (5, 9, 28) is provided in between the electrodes and the discharge chamber, characterized in that a precursor layer is applied to a substrate (1, 7, 23) comprising electrodes, the precursor layer comprising a metal alkoxide comprising, bound to the metal atom, an alkyl group and alkoxy groups and said precursor layer is subsequently converted to the dielectric layer.

10. Method as claim in claim 8, characterized in that the alkyl group is methyl or ethyl.

11. Method as claimed in claim 8, characterized in that the pre-cursor layer is applied by dip-coating, preferably in more than one layer.
